(19) United States
(12) Patent Application Publication
(10) Pub. No.: US 2002/0117769 A1
(43) Pub. Date: Aug. 29, 2002

(54) Foamed cellular particles of an expandable polymer composition

(76) Inventors: Paul Edward Arch, Coraopolis, PA (US); John Thomas Bressler, Beaver Falls, PA (US); Michel Florentine Jozef Berghmans, Breda (NL); Karel Cornelis Bleijenberg, Breda (NL); David Allen Cowan, Cranberry Township, PA (US)

Correspondence Address: Suzanne Kikel, NOVA Chemicals Inc., 400 Frankford Road, Monaca, PA, 15061, US

(21) Appl. No.: 10/021,716

(22) Filed: Nov. 30, 2001

Related U.S. Application Data
(60) Provisional application No. 60/251,140, filed on Dec. 4, 2000.
(60) Provisional application No. 60/254,205, filed on Dec. 8, 2000.

(51) Int. Cl. B29C 44/02; C08J 9/00

(52) U.S. Cl. 264/54; 521/50

(57) ABSTRACT

Foamed cellular particles made from an expandable polymer composition are formed at the plant of the polymer producer and shipped to the foam molder for making foam articles. The foamed cellular particles have a bulk density between 34.3 pounds per cubic foot (550 kilograms per cubic meter) and 12.5 pounds per cubic foot (200 kilograms per cubic meter) and a blowing agent e.g. pentane less than 6.0 wt %, i.e. ranging in an amount of 2.0 and 5.0 wt %, i.e between 2.5 and 3.5 wt %. These particles have an established cell structure and a fixed number of cells. The average cell size ranges between 5 and 100 microns. The foamed cellular particles are shipped to the foam molder a) in packages with a material strength that is less than the packages used for shipping expandable polymer particles and b) at a total shipment weight that is equal to the total shipment weight of the expandable particles. The foamed cellular particles can be used to form foam articles using conventional processes and equipment without the need to impregnate the foamed cellular particles with an additional amount of blowing agent.

### BACKGROUND OF THE INVENTION

1. Field of the Invention

The present invention relates to expandable polymer, e.g. polystyrene, particles used in making foamed articles. More particularly, the present invention relates to foamed cellular particles made from a polymer composition in the plant of the polymer producer and then packaged and shipped to the foam molder for making foamed articles.

2. Background Art

For many years, styrene polymer particles have been rendered expandable by the use of a blowing agent ranging from about 4.0 to about 9.0 weight percent (wt. %) that is intimately mixed with a polymer. These expandable particles are generally made as solid relatively “high-density” beads of a relatively small size, e.g. beads having a diameter of from about 0.2 to 4.0 millimeters. Generally, these styrene polymer particles are made by the resin or polymer producer and have a bulk density of about 40 pounds per cubic foot (641 kilograms per cubic meter). These expandable particles are shipped to the foam molder where they generally are partially expanded to a bulk density of about 6.0 pounds per cubic foot (96.1 kilograms per cubic meter) or less. After suitable aging, these particles are injected into a steam heated mold and are further expanded and fused together to form a foam article with a bulk density of about 6.0 pounds per cubic foot or less.

The most frequently used blowing agent is an organic blowing agent, for example a hydrocarbon liquid, such as n-pentane (normal pentane), butane, isopentane, and mixtures of pentane, the most common being n-pentane and mixtures of pentane.

N-pentane and mixtures of pentane are flammable and volatile organic compounds, and therefore considered environmentally undesirable in certain geographical areas, especially in the quantities that are released during the expansion and molding processes.

Furthermore, the residual pentane in the molded article continues to escape into the atmosphere after removal of the foam article from the mold. In an attempt to lessen or to eliminate this problem, various inorganic blowing agents, such as carbon dioxide, nitrogen, air and other pneumatogens have been used. The use of these inorganic blowing agents is disclosed in Meyer et al. U.S. Pat. No. 4,911,869. Because of the rapidity with which these gases diffuse out of the polymer particles, it is necessary to first pre-expand the particles and then re-impregnate the particles with the same or different gas just prior to molding. The use of inorganic gases as a blowing agent is also disclosed in Meyer et al U.S. Pat. No. 5,049,328. However, for reasons known to those skilled in the art, the organic gases, particularly pentane, remain the preferred blowing agent in expandable polystyrene particles.

Not only does the type of blowing agent influence the rate and the quality of expansion of the polystyrene particles, but the amount of blowing agent in the polystyrene particles is also a factor. If pentane is used as the blowing agent, the particles generally need to contain at least between 3.5 and 7.2% by weight of pentane when shipped to the foam molder. Lower pentane levels would tend to limit the ability of the particles to reach most bulk densities of commercial interest in a one-pass expansion process, the bulk density of commercial interest ranging from about 0.8 to 6.0 pounds per cubic foot (12.8 to 96.1 kilograms per cubic meter). Higher pentane levels will result in production inefficiencies such as poor quality moldings and long molding cycles, not to mention the additional emissions of pentane into the environment.

For some applications, it has become the practice to replace the one-pass expansion process at the foam molder's site with a multi-stage pre-expansion process, i.e. a two-stage expansion. This multi-stage pre-expansion process is required when converting the expandable particles with relatively low levels of blowing agent, e.g. less than 4.0% by weight pentane. In a two-stage expansion, the aim is to attain an intermediate density, e.g. less than 1.9 pounds per cubic foot (30.4 kilograms per cubic meter) in the first step. After aging, the particles are then expanded in a second step in order to lower the density of the particles to, for example, less than 0.80 pounds per cubic foot (12.8 kilograms per cubic meters). Some drawbacks of this two-stage expansion process are that the polymer particles need to be processed twice and intermediate storage is required, resulting in delays in the conversion of the expandable particles into foam articles by the foam molder. Also, this multi-stage pre-expansion process requires additional energy, labor, and equipment at the foam molder's site.

When the expandable particles are manufactured by the polymer producer and shipped to the foam molder, they are transported and/or stored at varying temperatures for varying times, thereby resulting in varying amounts of pentane being retained in the particles. Those skilled in the art will appreciate that these varying amounts of pentane in the expandable particles may generally have a deleterious effect on the quality and consistency of the resulting foam article.

Another drawback of the present practice of the polymer producer manufacturing the expandable styrene polymer particles and then shipping them to the foam molder is that the blowing agents are emitted into the environment at the site of the foam molder during the expansion and molding processes. If the blowing agent is hydrocarbon, then in order to reduce the emissions to acceptable regulatory levels for a given geographical region, the foam molder may be required to use expandable particles with a limited hydrocarbon content. If pentane is used, the content may range between 3.5% to 5.0% by weight of the polymer. The foam molder may also be forced to limit the amount of emissions by investing in complicated equipment for collecting the emitted hydrocarbons. These regulatory restrictions tend to limit the total annualized production rate of foam articles for the foam molder. Thus, the number of foam articles produced in the foam molder's plant in a given time will be dependent on the permissible regulatory levels for hydrocarbon emissions in a given geographical area. Additionally, since the foam molder generally has little reason to use the recovered hydrocarbon blowing agent emitted in the pre-expansion process and/or the foam molding process, he has little reason to invest in a system for recovering and/or recycling the blowing agent in his plant.

A further drawback of the present practice in shipping expandable styrene polymer particles to the foam molder is that the expandable particles must be specially packaged during transport in order to lessen the amount of hydrocarbon emissions into the atmosphere.

A still further drawback of the present practice in shipping expandable styrene polymer particles to the foam molder is the need to store the molded foam articles so that the residual hydrocarbon, i.e. pentane can dissipate prior to distribution of the foam articles. In the instance where large blocks are molded for use as thermal insulation, the blocks must be aged prior to hot-wire cutting into boards so as to allow the pentane to dissipate. If the blocks are insufficiently aged, fires can occur during the hot wire cutting process. If less pentane is in the particles during the molding processes, it is believed that less storage time would be required for the foam articles.

A still further drawback of the present practice is the limited shelf life of the expandable styrene polymer particles. Product quality requirements for the particles, such as the expansion rate and the potential for the particles to achieve the required low density levels, deteriorate over time due to the loss of blowing agent during shipment and/or storage. The latter occurs even when using special hydrocarbon-resistant plastic film liners inside the packages for shipping the particles. Often, additional quality control measures must be taken by the particle manufacturer prior to shipping the expandable particles if the particles are held in inventory for an extended length of time, e.g. three months or longer. Some particle manufacturers use expensive refrigerated storage in an effort to extend the effective shelf life of the expandable particles, especially if pentane is used as the blowing agent.

A further drawback of the present practice in shipping expandable styrene polymer particles to the foam molder is the weight restriction imposed by traffic and/or highway regulators. For example, the transportation regulatory bodies may restrict overall vehicle gross weight limit of 80,000 pounds for tractor-trailers hauling expandable particles without special permits. Due to this weight limitation, the tractor-trailers generally have empty volumetric space. After the packages or cartons carrying the expandable particles are carefully loaded into the tractor-trailer so that the weight is evenly spread over the trailer's axles, dunnage, such as inflatable air bags, are placed in the empty volumetric space in order to prevent the packages or cartons from shifting during transit.

A still further drawback of the present practice in shipping expandable styrene polymer particles to the foam molder is that special packaging is required. Expandable polymer particles in the size range of commercial interest generally have a relatively high bulk density compared to most non-expandable thermoplastic commodity resins, such as polyethylene, polypropylene, and solid (“crystal”) polystyrene. These non-expandable resins are often extruded into relatively large pellet sizes with an inefficient packing characteristic resulting in lower bulk densities compared to the typical expandable polymer particles, such as expandable polystyrene particles. Since the non-expandable resins do not contain a blowing agent, that in most instances is flammable, there is no concern with respect to fires or shelf life. Therefore, bulk shipment (e.g. in railroad hopper cars) of these non-expandable resins is very common.

Expandable particles, on the other hand, are packaged in relatively small packages, e.g. cardboard cartons, containing from about 1,000 to about 2,000 pounds of expandable resin. The high bulk density of these expandable particles requires the cartons to be manufactured with heavier and thicker cardboard than would be required if the non-expandable resins of lower bulk density were being shipped by a tractor-trailer. The heavier and thicker cardboard cartons, in turn, require stronger and more expensive wooden pallets to support the cartons on the tractor-trailer. Also, plastic film liners are placed in the cartons in order to lessen the dissipation rate of the blowing agent and to contain the blowing agent if it is volatile or flammable. These film liners are often multi-layered, are of a multi-composition, and are designed to take into account the high bulk density of the particles and the type of blowing agent in the expandable particles.

As discussed herein above, the use of inert blowing agents has been suggested and taught in the prior art in order to eliminate or alleviate some of the drawbacks of using a volatile-blowing agent in the expandable particles. Generally, the inert blowing agent (e.g. carbon dioxide) is incorporated into the particles immediately before the foaming step. This can be done as the particles are released from a heated impregnation vessel or when the particles are in an expander located in close proximity to the impregnation vessel. Therefore, in order to obtain the “low-density” foamed articles, e.g. 0.8 to 6.0 pounds per cubic foot (12.8 to 96.1 kilograms per cubic meter), the expandable particles need to be re-inflated with an additional blowing agent, e.g. air, immediately prior to the molding process. (A similar process is disclosed in the aforesaid Meyer et al. U.S. Pat. No. 4,911,869.) This may require the installation of large pressure vessels at the foam molder's site and a source of compressed gas, such as air.

German Patent Application DE 198 19 058 A1 teaches expandable polystyrene particles that are slightly foamed with a bulk density of 0.1-20% lower than the initial bulk density and with a coarse internal cell structure. Basically, this patent application teaches the production of coarse cells that would improve the thermal conductivity of the final molded foam article. It is believed by the inventors of the present invention, that the slight reduction in bulk density of the particles is not sufficient to significantly reduce the blowing agent content of the particles or to allow the use of less expensive standard resin packages or cartons. Additionally, if the cellular structure of the particles is “too coarse”, this can result in long molding cycles and in poor physical strength properties in the formed foam articles.

There is, therefore, a need for an improved system for preparing expandable polymer particles and for optimizing the shipping of the particles to the foam molder. There is also a need for an improved polymer particle used in making foamed articles.

### SUMMARY OF THE INVENTION

The invention has met the above needs. The invention provides a system whereby expandable polymer, e.g. styrene, particles that are intimately mixed or impregnated with a blowing agent, are formed into foamed cellular particles at the polymer producer's plant. The blowing agent may be a volatile organic compound (VOC) or a combination of a volatile organic compound and an inorganic compound, i.e. carbon dioxide, air, water, and nitrogen. Preferably, the blowing agent is pentane or a mixture of pentane.

These foamed cellular particles have a reduced bulk density, an established cell structure with a substantially fixed number of cells, and a reduced amount of blowing agent. These foamed cellular particles are packaged and shipped to the foam molder for the production of foam articles. Thus, the shipped particles contain a relatively low level of blowing agent for subsequent processing at the foam molder's site for producing foam articles.

The expandable polymer particles used as the starting material for producing the foamed cellular particles of the invention have a bulk density ranging from about 40 pounds per cubic foot (641 kilograms per cubic meter) to about 32 pounds per cubic foot (514 kilograms per cubic meter) and a blowing agent in an amount less than 10 wt %, preferably less than 9.0 wt %, and most preferably, ranging between 3.0 and 9.0 wt %, based on the weight of the polymer composition. These expandable polymer particles are heated at a temperature ranging between about 70° C and 110° C. and at a pressure ranging between about 10 psi absolute (70 kPa) and 24.7 psi absolute (170 kPa) to form the foamed cellular particles.

These foamed cellular particles have an established cell structure with a fixed number of cells, the number of which generally will not be increased when the foamed cellular particles are subjected to subsequent expansion and/or molding processes in the production of foam articles. This cell structure is a “fine” cell structure with an average cell size ranging between about 5 microns and 100 microns, preferably between 10 and 60, and more preferably, between 10 and 50 microns.

These foamed cellular particles have a bulk density ranging between about 34.3 pounds per cubic foot (550 kilograms per cubic meter) and 12.5 pounds per cubic foot (200 kilograms per cubic meter), and a blowing agent level less than 6.0 wt %, based on the weight of the polymer composition. Preferably, this blowing agent level ranges between about 2.0 and 5.0 wt %, and more preferably, ranges from about 2.5 and 3.5 wt % based on the weight of the polymer composition.

The foamed cellular particles are packaged in available standard resin packages. These resin packages have a strength that is lower than the packages currently used for shipping conventional expandable polymer particles. In transporting the foamed cellular particles of the invention, the total shipment weight of the foamed cellular particles is substantially equal to the total shipment weight of the conventional expandable particles when being shipped by the same transportation means, e.g. tractor-trailer. For a given weight load, the number of packages used in transporting the foamed cellular particles of the invention may be greater than the number of packages used for transporting the conventional expandable particles with a higher bulk density and a higher blowing agent level.

The inventors hypothesize that a greater percentage of the blowing agent may be dissolved in the polymer matrix of the foamed cellular particles of the invention. At the low weight percentages i.e. less than 6.0 wt. %, the blowing agent in the foamed cellular particles will not as readily dissipate during transportation compared to the conventional expandable particles (non-expanded) containing higher levels of blowing agent. The conventional expandable particles, which contain from about 3.5 wt % to 7.2 wt % pentane may have an effective shelf life of about 3 months. However, there is evidence as demonstrated in some of the examples herein that the foamed cellular particles of the invention have a longer shelf life than the conventional expandable particles. It is obvious that this factor becomes important if there are delays at both the polymer producer's site and at the foam molder's site. If the shelf life of the of foamed cellular particles of the invention is longer compared to that of conventional expandable polymer particles, then there may be a sufficient amount of blowing agent retained in the foamed cellular particles. If a sufficient amount of blowing agent is retained in the foamed cellular particles, this allows the foamed cellular particles to be pre-expanded and molded without the need to impregnate the particles with an additional amount of blowing agent prior to expanding and molding. It has been found that for a predetermined time at room temperature the blowing agent weight loss in the foamed cellular particles is about 15% to 50% lower compared to that of the expandable particles i.e. non-expanded particles in the same predetermined time at room temperature.

It is an object of the present invention to provide a system whereby foamed cellular particles having less than 6.0 wt % blowing agent which may be volatile organic compounds (VOC) and having a bulk density ranging between about 34.3 pounds per cubic foot (550 kilograms per cubic meter) and 12.5 pounds per cubic foot (200 kilograms per cubic meter) are formed at the polymer producer's site and then transported to the foam molder for the production of foam articles through the use of conventional expansion and molding equipment.

It is a further object of the present invention to prepare foamed cellular particles for use in making foam articles and to optimize the packaging and shipping of these particles by forming the foamed cellular particles at the polymer producer's site thereby allowing the use of lighter, less expensive standardized resin packages compared to the packages used in shipping conventional expandable particles.

It is a further object of the present invention to provide a system whereby the VOC emissions in the plant of the foam molder are reduced thereby allowing a greater production rate of foam articles in the foam molder's site and/or reducing the need for pentane collection equipment in order to comply with applicable regulatory emission standards and whereby pentane emissions occurring at the facilities of the polymer producer can be condensed and recycled.

These and other objects of the present invention will be better appreciated and understood by those skilled in the art from the following description and appended claims.

### DETAILED DESCRIPTION OF THE INVENTION

As used herein, “particles” refer to beads i.e. spherical in shape, generally produced in a polymerization process or to pellets generally produced in an extrusion process. As used herein, “conventional expandable particles” generally refer to expandable particles that have not been subjected to an expansion process, that are generally “high-density” beads having a diameter from about 0.2 to 4.0 millimeters, and that have a bulk density of about 40 pounds per cubic foot (641 kilograms per cubic meter).

In the invention, foamed cellular particles are formed at the plant of the polymer producer by using expandable polymer particles as the starting material. These foamed cellular particles are then shipped to the foam molder for use in a mold in the production of foam articles, such as cups, expanded blocks and/or shaped articles. The foamed cellular particles of the present invention have a sufficient amount of blowing agent such that they do not require any further pre-treatment nor do they need to be impregnated with any additional blowing agent at the foam molder's site. In addition, the foamed cellular particles have a certain fixed or established cell structure such that the number of cells in each particle does not change significantly during shipment, storage, and/or the foam molding processes.

The expandable polymer particles used to form the foamed cellular particles of the invention have a bulk density ranging between 40 pounds per cubic foot (641 kilograms per cubic meter) and 32.0 pounds per cubic foot (513 kilograms per cubic meter). When these particles are heated, the bulk density of the particles is reduced to between 34.3 pounds per cubic foot (550 kilograms per cubic meter) and 12.5 pounds per cubic foot (200 kilograms per cubic meter), preferably 25 pounds per cubic foot (400 kilograms per cubic meter). At this bulk density, the cell size of the foamed cellular particles is relatively small. For example, the average size of the cells of the foamed cellular particles ranges between about 5 to 100 microns, preferably between 10 and 60 microns, and most preferably between 10 to 50 microns. The average cell size is measured by cutting the foamed cellular particle in half and imaging each sample with a Hitachi S2500 electron microscope, using a 10 kilovolt energy beam, a 15 mm working distance, secondary electron detector imaging, and magnified from 100 to 1000 times.

As stated herein above, the foamed cellular particles of the invention have a reduced bulk density. This reduced bulk density can be interpreted to mean that for the same weight load capacity of the tractor-trailer, the number of packages used to ship the foamed cellular particles of the invention can be increased relative to the number of packages presently used to ship conventional expandable particles.

According to present practice, the expandable polymer particles are packaged in a standardized resin package known to one skilled in the art to be a standard package holding about 1,000 to about 2,200 pounds. Since the tractor-trailer can haul about 30,000 to 50,000 pounds, about 45 to 80 cartons can be used to ship the conventional expandable particles. However, if the tractor-trailer has a maximum load of, for example, 42,000 pounds, then for 1,000 pound cartons of expandable particles, 42 cartons would be used to ship a full truck load.

With the foamed cellular particles of the present invention, more cartons can now be shipped at the same total weight requirement as the conventional expandable particles. For example, for a 48 foot tractor-trailer, the entire space can be occupied with about 60 typical sized cartons containing foamed cellular particles of the invention with a bulk density of about 25 pounds per cubic foot (400 kilograms per cubic meter) while not exceeding the permissible gross vehicle weight limit of 80,000 pounds. The dunnage i.e. inflatable air bags can be eliminated since the tractor-trailer is now volumetrically full.

The total shipping volume of the foamed cellular particles is not increased significantly compared to the conventional expandable particles, and therefore, the transportation costs for the foamed cellular particles will not increase. Also, the average particle size of the foamed cellular particles is not increased significantly, i.e. not larger than 130% of the corresponding expandable polymer particles, i.e. the particles in an unexpanded state prior to being formed into foamed cellular particles.

The polymer composition of the expandable particles which form the foamed cellular particles may be a polymer or a blend of polymers. The polymeric material may comprise a substantial portion typically not less than 70, preferably not less than 80 weight % of one or more styrenic monomers and a minor amount, typically less than 30, preferably less than 20 weight % of rubber, a polyphenylene oxide polymer or a high impact styrenic polymer.

Suitable styrenic polymers comprise from 100 to 70 weight % of one or more C₈₋₁₂ vinyl aromatic monomers which are unsubstituted or substituted by one or more substituents selected from the group consisting of C₁₋₆, preferably C₁₋₄ alkyl radicals and halogen atoms, preferably chlorine and bromine atoms, and from 0 to 30 weight % of one or more components selected from the group consisting of monomers selected from the vinyl group consisting of C₃₋₆ ethylenically unsaturated carboxylic acids, anhydrides, imides, and C₁₋₁₂, preferably C₁₋₄ alkyl and alkoxyalkyl esters thereof, acrylonitrile and methacrylonitrile and optionally which may be grafted onto or occluded within one or more rubbers selected from the group consisting of (i) polymers of one or more C₄₋₅ conjugated diolefin monomers (diene rubbers), (ii) random, block or branched (star) copolymers comprising from 30 to 70, preferably from 40 to 60 weight % of one or more C₈₋₁₂ vinyl aromatic monomers which are unsubstituted or substituted with one or more substituents selected from the group consisting of C₁₋₄ alkyl radicals and from 70 to 30, preferably from 60 to 40 weight % of one or more C₄₋₅ conjugated diolefins (styrene butadiene rubbers or SBR, and block copolymers, SBS block copolymers and star or branched polymers) and (iii) random copolymers comprising from 40 to 60 weight % of one or more C₄₋₅ conjugated dienes and from 60 to 40 weight % of one or more monomers selected from the group consisting of acrylonitrile and methacrylonitrile (nitrile rubbers).

Suitable vinyl aromatic monomers include styrene, alpha methyl styrene, para methyl styrene, chlorostyrene and bromo-styrene. Suitable ethylenically unsaturated carboxylic acids include acrylic acid, methacrylic acid, and itaconic acid. Suitable anhydrides include maleic anhydride. Suitable imides include malimide. Suitable esters include methyl methacrylates, ethyl methacrylate, butyl acrylate, methyl acrylate, and ethyl acrylate. Suitable conjugated diolefins include butadiene (1,4-butadiene) and isoprene.

A preferred vinyl aromatic monomer is styrene.

Suitable polymers include polystyrene, styrene acrylates, copolymers of styrene and esters of acrylic or methacrylic acid, copolymers of styrene and acrylonitrile (SAN), high impact polystyrene (HIPS—i.e. styrene monomer polymerized and grafted onto and/or occluded within from about 2 to 12, preferably from 4 to 10 weight % of a diene rubber), and styrene acrylonitrile copolymerized in the presence of from 2 to 12, preferably from 4 to 10 weight % of diene rubber or a nitrile rubber (ABS).

The polymeric component may be blends of the above polymers provided the vinyl aromatic component is not less than about 70 weight %. The blends may also include up to about 30 weight % of polyphenylene oxide. For example, the blend could be a blend of 70 or more weight % of styrene and up to 30 weight % of polyphenylene oxide. The blend could be a predominant amount of a styrene acrylate or methacrylate polymer (e.g. styrene methyl methacrylate) and one or more block copolymers of styrene and butadiene (some blends of which are sold by NOVA Chemicals as ZYLAR® resin).

The foamed cellular particles are made from expandable polymer particles that are made expandable by a blowing agent.

Organic blowing agents are well known to those skilled in the art and are typically acetone, methyl acetate, butane, n-pentane, hexane, isobutane, isopentane, neopentane, cyclopentane and cyclohexane. Other blowing agents used in making polymer particles expandable are HFC'S, CFC'S, and HCFC'S, and mixtures thereof.

In the present invention, the blowing agent can be acetone, methyl acetate, butane, n-pentane, cyclopentane, isopentane, isobutane, neopentane, and mixtures thereof. A preferred blowing agent is normal pentane and mixtures of pentane. For the expandable polymer particles used in the invention, any of the preceding blowing agents may also be used in combination with carbon dioxide, air, nitrogen, and water.

The blowing agent level of the expandable polymer particles generally will be less than 10.0 weight %, preferably less than 9.0 weight %, and most preferably will range from between about 3.0 wt % and about 9.0 wt %, based on the weight of the polymer composition.

If the polymer of the particles is a styrenic polymer, then the weight-average mean molecular weight of the styrenic polymer is greater than 130,000.

Expandable particles from which the foamed cellular particles of the invention may be obtained can be prepared by various methods. These include polymerization and extrusion processes.

In the polymerization process, the polymer composition is polymerized to a conversion greater than 99%. The polymerization process may include bulk polymerization, solution polymerization, and suspension polymerization techniques. The blowing agent may be added before, during or after the polymerization process.

A preferred polymerization process for the production of expandable particles is suspension polymerization. In this process, a polymer composition is polymerized in an aqueous suspension in the presence of from 0.1 to 1.0% by weight of a free radical initiator and the blowing agent.

For the suspension polymerization many methods and initiators are known to those skilled in the art. In this respect reference is made to e.g., U.S. Pat. Nos. 2,656,334 and 3,817,965 and European Patent Application No. 488,040. The initiators disclosed in these references can also be used to make the expandable particles that in turn are used to make the foamed cellular particles of the present invention. Suitable initiators are organic peroxy compounds, such as peroxides, peroxy carbonates and peresters. Typical examples of these peroxy compounds are C₆₋₂₀ acyl peroxides, such as decanoyl peroxide, benzoyl peroxide, octanoyl peroxide, stearyl peroxide, peresters, such as t-butyl perbenzoate, t-butyl peracetate, t-butyl perisobutyrate, t-butylperoxy 2-ethylhexyl carbonate, carbonoperoxoic acid, OO-(1,1-dimethylpropyl) O-(2-ethylhexyl) ester, hydroperoxides and dihydrocarbyl peroxides, such as those containing C₃₋₁₀ hydrocarbyl moieties, including di-isopropyl benzene hydroperoxide, di-t-butyl peroxide, dicumyl peroxide or combinations thereof. Other initiators, different from peroxy compounds, are also possible, as for example α,α′-azobisisobutyronitrile.

The suspension polymerization is carried out in the presence of suspension stabilizers. Suitable suspension stabilizers are well known in the art and comprise organic stabilizers, such as poly (vinyl alcohol), gelatine, agar, polyvinyl pyrrolidine, polyacrylamide;inorganic stabilizers, such as alumina, bentonite, magnesium silicate; surfactants, such as sodium dodecyl benzene sulfonate; or phosphates, like tricalciumphosphate, disodium-hydrogen phosphate, optionally in combination with any of the stabilizing compounds mentioned earlier. The amount of stabilizer may suitably vary from 0.001 to 0.9% by weight, based on the weight of the aqueous phase.

The expandable particles may also contain an anti-static additive; a flame retardant; a colorant or dye; a filler material, such as carbon black, titanium dioxide, aluminum, and graphite, which are generally used to reduce thermal conductivity; stabilizers; and plasticizers, such as white oil or mineral oil. The particles may suitably be coated with coating compositions comprised of white oil or mineral oil, silicones, metal or glycerol carboxylates, suitable carboxylates being glycerol mono-, di- and tri-stearate, zinc stearate, calcium stearate, and magnesium stearate; and mixtures thereof. Examples of such compositions have been disclosed in GB Pat. No. 1,409,285 and in Stickley U.S. Pat. No. 4,781,983.

The coating composition can be applied to the particles via dry coating or via a slurry or solution in a readily vaporizing liquid in various types of batch and continuous mixing devices. This coating aids in preventing the formation of agglomerates during the production of the foamed cellular particles. This increases the prime conversion of expandable particles into foamed cellular particles. Once foamed cellular particles are formed, they may also be optionally coated with additional coatings of similar compositions. The coating composition may be applied to the expandable polymer particles, or to the foamed cellular particles or to both the expandable polymer particles and to the foamed cellular particles. As known to those skilled in the art, these coating compositions can reduce agglomeration during the final pre-expansion step and can also affect molding properties such as the pressure decay time or molding cycle cool time. The coating composition may also aid in acquiring higher expansion rates for the foamed cellular particles compared to the expansion rate for conventional expandable polystyrene (EPS) (Experiment 9). Addition of coatings such as mineral oil or white oil at the molders' location is also possible. For example mineral oil can be added just following pre-expansion and/or just prior to foam molding. This technology is sometimes used with conventional expandable polystyrene products and is known to those skilled in the art.

The expandable polymer particles, and therefore the foamed cellular particles may contain various additives, such as chain transfer agents, suitable examples including C₂₋₁₅ alkyl mercaptans, such as n-dodecyl mercaptan, t-dodecyl mercaptan, t-butyl mercaptan and n-butyl mercaptan, and other agents such as pentaphenyl ethane and the dimer of α-methyl styrene. The expandable polymer particles may contain cross-linking agents, such as butadiene and divinylbenzene, and nucleating agents, such as polyolefin waxes. The polyolefin waxes, i.e.,polyethylene waxes, have a weight average molecular weight of 500 to 5,000, which are typically finely divided through the polymer matrix in a quantity of 0.01 to 1.0% by weight, based on the amount of polymer composition. The particles may also contain from 0.1 to 0.5% by weight, talc, organic bromide-containing compounds, and polar agents as described in e.g. WO 98/01489 which comprise isalkylsulphosuccinates, sorbital-C₈-C₂₀-carboxylates, and C₈-C₂₀-alkylxylene sulphonates.

Nucleating agents are particularly useful because they tend to improve the formation of cells.

The polymer composition of the invention may be comprised of a styrenic monomer with an amount of an acrylate monomer in an amount in a range of about 0.3 to about 5.0 weight percent based on the amount of styrenic monomer. Suitable acrylate monomers include, but are not limited to, methyl acrylate, ethyl acrylate, n-butyl acrylate, n-hexyl acrylate, 2-ethylhexyl acrylate, cyclohexyl acrylate, 2-ethoxyethyl acrylate, 2-methoxyethyl acrylate, n-octyl acrylate, lauryl acrylate, 2-phenoxyethyl acrylate, benzyl acrylate, decyl acrylate, methyl methacrylate, ethyl methacrylate, n-butyl methacrylate, 2-ethylhexyl methacrylate, allyl methacrylate, cyclohexyl methacrylate, stearyl methacrylate, lauryl methacrylate, and the like, and mixtures thereof. A preferred acrylate monomer is n-butyl acrylate. Such acrylate monomers are known to lower the T_{g} of the polymer which, in turn, improves the expandability of the polymer particles whereby the expandable particles require a lower amount e.g. less than 2.5 weight percent of blowing agent, eg. pentane. The method for copolymerizing styrene monomer and acrlyate monomer is taught in U.S. Pat. No. 5,240,967 to Sonnenberg, et al. that is now assigned to the assignee of this patent application. All the teachings of this '967 patent are incorporated herein by reference.

The suspension polymerization is suitably carried out in the plant of a polymer producer in a one-step or a two-step time/temperature-controlled process. In both processes, a pre-programmed time/temperature reaction cycle is used over the range of 80° C. to 140° C., depending on the type and amount of initiator used in the polymerization process and depending on the desired molecular weight, molecular weight distribution, and styrene residual of the polymer. Products of commercial interest typically contain less than 1,000 parts per million (PPM) residual styrene and have a weight-average molecular weight greater than 130,000. In addition to these physical properties, particle size is also important for the expandable particles. Products of commercial interest range from about 0.2 mm. to about 3.0 mm. Those skilled in the art will readily appreciate and understand the manner in which the reaction formulation and the conditions of the polymerization process can be controlled in order to achieve the desired results for the above physical properties of the cellular foamed particles of the invention.

In a suspension polymerization process, the polymer composition may comprise a styrenic monomer in an amount ranging from 70 to 100, preferably, from 80 to 100 weight percent, based on the polymer composition where the styrenic monomer may be admixed with a at least a vinyl group monomer such as those listed herein above in an amount ranging from about 30 to 0 weight %, preferably, 20 to 0 weight %, based on the polymer composition. Or the polymer composition may comprise a styrenic monomer in an amount ranging from 70 to 100 weight % based on the polymer composition admixed with at least one polymer selected from the group consisting of polyphenylene oxide, butadiene rubber, and high impact polystyrene in an amount ranging from 30 to 0 weight % based on the polymer composition.

The expandable polymer particles of a polymer composition for use in the invention can be also formed via an extrusion process. In the extrusion process the polymer composition may comprise a styrenic polymer in an amount ranging from 70 to 100 weight % based on the polymer composition admixed with at least one vinyl group polymer in an amount ranging from 30 to 0 weight % based on the polymer composition. Or the polymer composition may comprise a styrenic polymer in an amount ranging from 70 to 100 based on the polymer composition admixed with at least one polymer in an amount ranging from about 30 to 0 weight % based on the polymer composition and selected from the group consisting of polyphenylene oxide, butadiene rubber, and high impact polystyrene.

The polyphenylene oxide, butadiene rubber, and high impact polystyrene of the polymer composition, preferably is added to improve the performance properties of the polymer composition, e.g. mechanical, thermal, physical, and chemical properties. This additional polymer may be added before or during the suspension polymerization or the extrusion processes, or the components of the polymer composition may be mixed together by a static or dynamic mixer in a well-known manner in situ prior to the start of the polymerization and/or extrusion processes. Suitable polyphenylene oxides used herein may be those described, for example, in EP-A-350137, EP-A-403023 and EP-A-391499.

In the extrusion process, a single-screw or a multi-screw extruder may be used. One method for preparing foamed particles involves injecting the blowing agent into the extruder, extruding pellets, and either letting the pellets expand or expanding the pellets through a process well known to those in the art. More particularly, the blowing agent is mixed into the molten polymer composition, which is drawn through a plurality of holes in the die face to produce strands. The extruded strands are cut into expandable polymer particles by a conventional under-water face-cutting apparatus or cooled in a water bath and subsequently cut by a pelletizing chopper into pellets having a length ranging from about 0.2 mm to about 3.00 mm. Foamed cellular particles are then formed from these expandable particles via a heating/pressure process described herein.

Another method for preparing foamed particles via an extrusion process involves the extrusion of the molten polymer composition through the die face, chopping the strands into pellets, and impregnating the pellets. Foamed cellular particles from these expandable particles are then formed via a heating/pressure process described herein.

A further variation of the extrusion process involves the expandable particles being formed into foamed cellular particles at the die face instead of downstream from the extruder. In this instance, heat from the extruder that is inherent in the strand or pellet will cause the blowing agent to vaporize and to expand within the matrix of the strand or pellet to form the foamed cellular particles of the invention. The temperature in the extruder may range between 200 and 250° C. and its pressure may range between 300 psia and 3,000 psia. It will be appreciated that the amount of blowing agent and heat in the extruder, and the type of cooling means used at the die face can be controlled to obtain the desired bulk density of and the desired amount of blowing agent in the foamed cellular particles of the invention.

The expandable particles may be formed in an extruder where a polymerization process forms the polymer composition. The components of the polymer composition along with an initiator and other additives may be introduced into the extruder. This process generally will include the step of admixing a styrenic monomer in an amount ranging between about 70 and 100 weight % based on the amount of monomer composition with at least one vinyl group monomer in an amount ranging between 30 and 0 weight % based on the monomer composition. Similarly to that taught herein above with regard to the extrusion processes, the blowing agent can be mixed into the molten composition before it is drawn through the die face to produce strands which are then cut into pellets or the pellets can be impregnated with the blowing agent which are subsequently formed into foamed cellular particles or foamed cellular particles can be formed at the die face.

In the polymerization, extrusion, and the polymerization-extruder processes described herein above, the expandable particles have a bulk density ranging between 40 pounds per cubic foot (641 kilograms per cubic meter) and 32.0 pounds per cubic foot (513 kilograms per cubic meter). These particles are heated between 70° C. and 110° C., preferably between 80° C. to 110° C. and are simultaneously subjected to a pressure of 10.1 psi absolute (70 kPa) to about 24.7 psi absolute (170 kPa), preferably 95 kPa to 110 kPa absolute, for a time ranging from 1 minute to 60 minutes to form foamed cellular particles.

The foamed cellular particles have a reduced bulk density ranging between about 34.3 pounds per cubic foot (550 kilograms per cubic meter) and 12.5 pounds per cubic foot (200 kilograms per cubic meter). Preferably, the bulk density of the foamed cellular particles ranges between 28.1 pounds per cubic foot (450 kilograms per cubic meter) and 21.9 pounds per cubic foot (350 kilograms per cubic meter), and more preferably, the bulk density is about 25 pounds per cubic foot (400 kilograms per cubic meter). The blowing agent level of the foamed cellular particles is less than 6.0 weight % based on the weight of the polymer composition, preferably ranges between 2.0 wt % and 5.0 wt %, and more preferably ranges between about 2.5 weight % and 3.5 weight %. The foamed cellular particles have an average particle size ranging between about 0.2 and 3 mm, preferably between about 0.3 and 2 mm. Each particle has an average cell size ranging between about 5 and 100 microns, preferably between 10 and 60 microns, and most preferably between 10 and 50 microns.

The heating process utilized in the invention in forming the foamed cellular particles from the expandable solid particles may be carried out in a fluidized bed in a batch or continuous heating process, with or without mechanical agitation or vibration. Other suitable heating methods may include contact heating, non-contact heating, infrared heating, microwave heating, dielectric heating, and radio frequency heating.

Pre-expander equipment as generally used for the processing of expandable particles is suitable for the preparation of the foamed cellular particles of the invention. An example of such a pre-expander is Hirsch® 3000 provided by the Hirsch Company.

The foamed cellular particles of the invention have been found to exhibit equivalent or superior expandability characteristics compared to the conventional expandable particles. This includes the expansion throughput rates and the ability of the foamed particles to achieve a required final low density, i.e. about 0.8 to 6.0 pounds per cubic foot (12 to 30 kilograms per cubic meter) for the foamed articles at the foam molder's plant when using conventional expansion and molding equipment.

In general, the shelf life of the polymer particles can be correlated to the rate at which the blowing agent dissipates from the particles. It is the inventors' belief that the foamed cellular particles of the invention have a longer shelf life compared to the conventional expandable particles. It is hypothesized that this occurs for one or more of the following reasons: 1) Since there are lower pentane levels in the foamed cellular particles, there is less driving force for diffusion of the pentane out of the cells of the particles. 2) Since the foamed cellular particles are larger than the conventional expandable particles, the mean path for diffusion of the pentane through the particle is longer. For a predetermined time, at room temperature the foamed cellular particles have a blowing agent weight loss at least 15% to 50% lower than that of the expandable particles in the same time at room temperature. 3) The cellular structure of the foamed cellular particles may inherently better retain the blowing agent.

For storage and shipping purposes, the foamed cellular particles of the invention are placed in a pentane-resistant plastic bag that is closed at the top by a wire tie. The bag is supported in a carton and then shipped to the foam molder. The cartons for the foamed cellular particles can have a material compressive strength of 10,000 pounds. It is believed that this material strength can be less than that being used when shipping conventional expandable particles in specialized cartons with a material strength of about 12,000 pounds. This would be possible since the foamed cellular particles in their low bulk density form weigh less per unit volume than the expandable particles.

When being shipped, the foamed cellular particles will have a total shipment weight substantially equal to the total shipment weight of the expandable particles. If the total maximum weight a tractor-trailer can transport is 30,000 to 50,000 pounds, the number of cartons used in transporting the foamed cellular particles may range respectively between 45 and 80.

Even though cartons have been described above for shipping the foamed particles of the invention, it is to be understood that other packages can be used in transporting the foamed cellular particles to the foam molder. For example, plastic-film bags, metal drums, fiber drums, bulk bags, and packaging that is returnable/reusable can be used. Bulk transport can also be used with suitable safety precautions when handling particles containing flammable organic blowing agents.

In practicing the invention, i.e. forming expandable particles into foamed cellular particles at the polymer producer's site and then shipping the foamed cellular particles to a foam molder for the subsequent production of foamed articles, the properties of the foam articles, such as mechanical strength and particle fusion, will be at acceptable levels.

It is to be appreciated that the foamed cellular particles of the invention can be pre-expanded and molded into foam articles by conventional steam expansion and molding methods, and as mentioned herein above, and with conventional equipment without the need to impregnate the foamed cellular particles with an additional amount of blowing agent. The foam articles will have a bulk density ranging between about 0.50 pounds per cubic foot (8.0 kilograms per cubic meter) and about 6.0 pounds per cubic foot (96.1 kilograms per cubic meter).

It is to be further appreciated that the hydrocarbon blowing agents emitted during the production of the foamed cellular particles of the invention can be captured, condensed and recycled into the processes for manufacturing the expandable polymer particles or burned at the polymer producer's plant. The methods and equipment for doing this are conventional. It is to be further appreciated that at the polymer producer's plant, the levels of VOC emissions in forming foamed cellular particles of the invention can be controlled within the allowed regulatory standards for the respective geographical area, and that at the foam molder's plant, these levels are reduced.

### EXAMPLES

The following examples are intended to aid in understanding the present invention. However, in no way, should these examples be interpreted as limiting the scope thereof.

The experimental foamed cellular particles were prepared in a lab or pilot plant and were evaluated with some small-scale commercial equipment. Batch expansion was done by using either a non-agitated, 2-gallon batch expander with a perforated screen bottom supporting the particles that were subjected to steam at atmospheric pressure or by using a Hirsch® 3000 pressure expander (Preex 3000). The pentane percentage was measured by headspace gas chromatography, the method of which is well known to those skilled in the art. The headspace unit is a Hewlett Packard Model 7694 gas chromotograph auto-sampler with a heated transfer line and septum needle termination. The oven temperature was 125° C. The temperatures for both the transfer line and the sample loop were 150° C. The gas chromatograph is a Hewlett Packard Model 5890 with split/splitless capillary inlet and a flame ionization detector. The column used in the gas chromatography was a J&W, DB-1, with a 30 m×0.53 mm capillary and a 1.50 um film-thickness. Bulk density was measured using a 25 millimeter graduated cylinder and a certified analytical balance.

### Example 1

This Example 1 illustrates that the blowing agent retention of the foamed cellular particles of the invention may be increased compared to a control comprised of conventional expandable particles.

Commercially available expandable polystyrene particles were used as the control and as the starting material in the production of the experimental foamed cellular particles. The expandable polystyrene particles were produced using a “two-step” process with an initial suspension polymerization followed by a subsequent impregnation process. The resulting expandable particles contained hexabromo-cyclododecane as a fire retardant and a mixture of normal pentane, isopentane, and cyclopentane as the blowing agent along with other typical additives, such as a lubricant coating, e.g. glycerol-monostearate.

For the control, a sample of expandable polystyrene particles contained a total pentane content of 4.24 wt % as measured by headspace gas chromatography. These expandable particles had a bulk density of 37.85 pounds per cubic foot (606 kilograms per cubic meter) and an average particle size of 0.886 mm. The particles were placed on a tray in a single layer and left for 19 days at room temperature. The total pentane content in the expandable particles after 19 days decreased from 4.24 wt % to 2.71 wt % based on the weight of the polymer. This was a reduction of 36% total pentane content in the particles.

For the experimental particles, foamed cellular polystyrene particles were prepared from the same starting material as the control. To form these foamed cellular particles, one pound (454 grams) of the expandable particles was placed in a fluid bed dryer with a glass body (Lab-Line Hi-Speed Fluid Bed Dryer Model #23850 (1985)) and was subjected to atmospheric pressure with an inlet air temperature of 85° C. for 25 minutes. The resulting foamed cellular particles had a bulk density of 26.37 pounds per cubic foot (422 kilograms per cubic meter) and a total pentane content of 3.86 wt % as measured by headspace gas chromatography (GC). The average particle size was 1.155 mm. The particles were arranged in a single layer on a tray and left for 19 days at room temperature. The total pentane content in the particles after 19 days decreased from 3.86 wt % to 3.11 wt % based on the weight of the polymer. This was a reduction of 19% total pentane content in the particles. Thus the experimental foamed cellular particles had a higher percent, i.e. 47% blowing agent retention capacity compared to the control particles.

### Example 2

This Example 2 illustrates that the expansion rate for the foamed cellular particles of the invention may be at least comparable to the expansion rate for the control expandable particles. The expandable particles were taken from the same batch of expandable polystyrene particles used in Example 1. For the control, 3.5 pounds (1589 grams) of pre-weighed expandable polystyrene particles were used. These particles had an initial bulk density of 38.05 pounds per cubic foot (609.5 kilograms per cubic meter). These particles contained 4.30 wt % pentane as measured by headspace gas chromatography. The particles were pre-expanded in batch form in the Hirsch® 3000 pressure expander at a steam pressure of 0.33 bar and a throughput rate of 113 pounds per hour to form what is referred to in the art as “pre-puff” particles, i.e. particles that are expanded prior to aging and molding. The bulk density of the pre-puff particles was 0.88 pound per cubic foot (14.1 kilograms per cubic meter).

Foamed cellular particles of the invention were formed in a batch-wise process by placing 10 pounds (4.54 kilograms) of expandable particles similar to those used in the control in a fluid bed dryer that was 1.229 ft in diameter. The batch time was 20 minutes and the temperature was 87° C. The resulting bulk density of these foamed cellular polystyrene particles was 18.41 pounds per cubic foot (295 kilograms per cubic meter). These foamed cellular particles contained 3.48 wt. % pentane as measured by headspace gas chromatography. The foamed cellular particles were then pre-expanded in batch form in the pressure expander at a steam pressure of 0.33 bar and a throughput rate of 113 pounds/hour. The resultant pre-puff bulkdensity was 0.88 pounds per cubic foot (14.1 kilograms per cubic meter). This is equivalent to the bulk density obtained for the control sample even though the foamed cellular particles contained 19% less pentane than that of the control sample.

Following a normal conditioning period, i.e., about 4 to 24 hours, the pre-puff particles of the control and the pre-puff particles produced from the foamed cellular particles were steam molded into a block in a commercially-available Wieser® molding machine with dimensions of 2490 mm×640 mm×740 mm. The two resulting blocks were aged and cut into boards using heated electric wires. Core samples were tested on an INSTRON 4204 Model instrument with Series lX Version 8.08.00 software using the following methods for obtaining density and compressive resistance measurements:

Density:

ASTM D1622 “Test Method for Apparent Density of Rigid Cellular Plastics”

Compressive Resistance at 10% Deformation:

ASTM D1621 “Test Method for Compressive Properties of Rigid Cellular Plastics”

The results for both samples met the compressive resistance requirements for Type I rigid cellular polystyrene thermal insulation as outlined in ASTM C578 “Standard Specification for Rigid, Cellular Polystyrene Thermal Insulation”.

This Example illustrates that even with the lower pentane level of the sample containing the foamed cellular particles, i.e. 3.48 wt % pentane, equivalent expansion results were obtained compared to the control sample of the expandable particles with the higher pentane level, i.e. 4.30 wt. % pentane.

### Example 3

Commercially available expandable polystyrene particles were used for both the control and for the starting material for the production of foamed cellular particles. The expandable polystyrene particles were produced using a “one-step” suspension process in which pentane blowing agent was introduced into the on-going polymerization process. The resulting expandable particles contained hexabromo-cyclododecane as a fire retardant and 100% normal pentane as the blowing agent in addition to other conventional additives.

For the control, a sample of the expandable polystyrene particles had a pentane content of 5.93 wt % as measured by headspace gas chromatography. These expandable particles had a bulk density of 36.88 pounds per cubic foot (591 kilograms per cubic meter) and an average particle size of 0.754 mm. The particles were placed on a tray in a single layer and left for 20 days at room temperature. The pentane content remaining in the particles after 20 days decreased from 5.93 wt % to 3.95 wt %. This was a 33% pentane reduction in the particles.

For the experimental particles of the invention, foamed cellular polystyrene particles were prepared from the same starting material as the control. One pound (454 grams) of the expandable polystyrene particles was placed in the fluid bed dryer used in Experiment 1 and the particles were subjected to atmospheric pressure with an inlet air temperature of 78° C. for 50 minutes. The resulting foamed cellular particles had a bulk density of 24.22 pounds per cubic foot (388 kilograms per cubic meter) and a pentane content of 4.66 wt %. The average particle size was 0.863 mm. The particles were arranged in a single layer on a tray and left for 20 days at room temperature. The pentane content in the particles after 20 days had decreased from 4.66 wt % to 3.46 wt %. This was a 26% pentane reduction in the foamed cellular particles. Thus the foamed cellular particles appear to better retain the blowing agent compared to the control particles.

### Example 4

The control expandable polystyrene particles with a pentane level of 5.93 wt % and the experimental foamed cellular particles of the invention with a pentane level of 4.66 wt % used in Example 3 were also used in Example 4. Fifty (50) grams of the particles were added to a non-agitated, 2-gallon batch expander with a perforated screen bottom. Atmospheric steam was introduced through the screen into the bottom of the expander and the particles were expanded for 2 minutes. Each experiment was done in duplicate. Through visual inspection, the control samples, i.e. the expandable polystyrene particles, exhibited significant agglomeration and “lumping” during expansion. This was expected since the expander was not agitated. Contrary to this, the experimental foamed cellular particles were free flowing and displayed no agglomeration during batch expansion even though the expander was not agitated. Table 1 contains the data for this Example 4:

TABLE 1

| | | AVERAGE BULK |
|---|---|---|
| | EXPANSION | DENSITY (pounds |
| SAMPLE | TIME | per cubic foot) |
| Control with 5.93% Pentane | 0 minutes | 36.88 |
| Control with 5.93% Pentane | 2 minutes | 0.95 |
| Foamed Cellular Particles | 0 minutes | 24.22 |
| with 4.66% Pentane | | |
| Foamed Cellular Particles | 2 minutes | 0.95 |
| with 4.66% Pentane | | |

The data in Table 1 indicates that the same expansion occurs, i.e. a bulk density of 0.95 pounds per cubic foot is obtained for both the control sample with the higher pentane level of 5.93 wt % and the experimental sample with the lower pentane level of 4.66% wt %.

### Example 5

Example 5 illustrates that the blowing agent retention of the foamed cellular particles of the invention may be increased compared to a control comprised of expandable particles that are produced in an extrusion process.

Commercially available expandable polystyrene extruded pellets were used as the control and as the starting material in the production of experimental foamed cellular particles of the invention. The expandable polystyrene particles were produced using an extrusion process in which pentane as the blowing agent was mixed with polystyrene and extruded through a die and the strands cooled and cut to produce expandable cylindrical pellets. The resulting expandable pellets contained carbon black and 100% isopentane as the blowing agent along with other conventional additives, such as a lubricant coating.

For the control, the expandable polystyrene pellets contained 4.68 wt % isopentane as measured by headspace gas chromatography. These cylindrical expandable particles had a bulk density of 32.79 pounds per cubic foot (525.2 kilograms per cubic meter) and an average length of 2.23 mm. and an average diameter of 0.62 mm. These particles were placed on a tray in a single layer and left for 21 days at room temperature. The total isopentane content in the control particles after 21 days decreased from 4.68 wt % to 4.54 wt %. This is a reduction of 3% of the isopentane content in the particles.

The experimental foamed cellular polystyrene particles were prepared from the same starting material as the control. One pound (454 grams) of experimental particles was prepared at atmospheric pressure with an inlet air temperature of 80° C. for 25 minutes in a fluid bed dryer with a glass body (Lab-Line Hi-Speed Model #23850). The resultant foamed cellular particles had a bulk density of 23.75 pounds per cubic foot (380.4 kilograms per cubic meter) and a total isopentane content of 4.34 wt % as measured by headspace gas chromatography. The average particle was approximately spherical in shape with an approximate diameter of 1.14 mm. The particles were arranged in a single layer on a tray, and were left for 21 days at room temperature. The total isopentane content in the particles after 21 days had decreased from 4.34 wt % to 4.27 wt %. The total isopentane content in the particles was reduced 1.6%. Thus, the experimental foamed cellular particles had a higher, i.e. 46% blowing agent retention capacity compared to the control particles.

The amount of blowing agent that is lost in the particles over time has a deleterious effect on the expansion and molding performance of expandable particles. The foamed cellular particles of the invention indicate a tendency to improve the amount of blowing agent retained in the particles.

### Example 6

This Example illustrates that the blowing agent retention of the foamed cellular particles of the invention compared to a control of expandable particles may be increased. In this Example, impregnated, extruded pellets made from high-impact polystyrene were used as the starting material. The rubber content was 3.5%.

Commercially available expandable high-impact polystyrene extruded pellets were used for both the control and for the starting material for the production of experimental foamed cellular particles. The expandable high-impact polystyrene was produced using an extrusion process in which pentane used as the blowing agent was mixed with high-impact polystyrene and extruded through a die and the strands were cooled and cut to form expandable cylindrical pellets. The resulting expandable pellets contained 40% normal pentane(n-pentane) and 60% isopentane as the blowing agent along with other conventional additives, for example, a lubricant coating.

For the control, a sample of expandable polystyrene pellets contained a total pentane content of 3.89 wt % as measured by headspace gas chromatography. These cylindrical expandable particles had a bulk density of 33.24 pounds per cubic foot (532 kilograms per cubic meter) with an average length of 2.09 mm. and an average diameter of 0.56 mm. The particles were placed on a tray in a single layer for 21 days at room temperature. The total pentane content in the particles after 21 days decreased from 3.89% to 3.40%. This was a reduction of 12.6% total pentane content in the particles.

The experimental foamed cellular particles were prepared from the same starting material as the control of this Example. One pound (454 grams) of experimental particles was prepared at atmospheric pressure with an inlet air temperature of 90° C. for 25 minutes in a fluid bed dryer used in Example 1. The resulting foamed cellular particles had a bulk density of 25.32 pounds per cubic foot (405 kilograms per cubic meter) and a total pentane content of 3.55 wt % as measured by headspace gas chromatography. The average particle size was 1.15 mm in diameter and was approximately spherical in shape. The particles were arranged in a single layer on a tray 21 days at room temperature. The total pentane content in the particles after 21 days decreased from 3.55 to 3.41%. This was a reduction of 3.9% total pentane content in the particles. Thus the experimental foamed cellular particles had 69% better blowing agent retention than the control particles.

As stated in Example 5, the amount of blowing agent that is lost in the particles over time has a deleterious effect on the expansion and molding performance of expandable particles. This Example 6 also gives an indication that the foamed cellular particles of the invention have a tendency to improve the amount of blowing agent retained in the particles.

### Example 7

This Example 7 demonstrates the production of foamed cellular particles using direct steam contact in a mechanically agitated device instead of using hot air in a fluidized bed.

The starting material was expandable polystyrene (EPS) containing 2.99% normal pentane, 0.33% cyclopentane, and 0.01% isopentane. The average particle size was 0.945 mm. The material had a starting bulk density of approximately 39 pounds per cubic foot. The material was coated with a surface coating of 500 ppm zinc stearate. A Hirsch® Vacutrans 3000-H batch pre-expander was used to produce the foamed cellular particles. The conditions used were:

| | |
|---|---|
| Steam Pressure (psig) | 0.50 (air + steam) |
| Inlet Temperature | 100° C. |
| Steam Time | 53 sec. |
| Total Cycle Time | 74.5 sec. |
| Expandable Particles | 25.1 lbs. |
| Feed Charge Weight | |
| Resulting Foamed Cellular | 25.0 pcf. |
| Particles Product | |
| Bulk Density | |
| Equivalent Production | 1221 lbs./hr. |
| Rate | |

The resulting foamed cellular particles had an average particle size of 1.148 mm and contained 2.86% normal pentane, 0.39% cyclopentane, and 0.02% isopentane.

### Example 8

A copolymer of styrene and n-butyl acrylate was used as the expandable particle starting material. The expandable particles were prepared in a suspension polymerization process with a monomer blend of 98.5 weight percent styrene and 2.5 weight percent n-butyl acrylate based on the copolymer weight, not including the blowing agent. The copolymer was then suspension impregnated with normal pentane as the blowing agent. Suitable suspending agents, surfactants, and time/temperature exposure were used to conduct the impregnation process as are known to those skilled in the art.

Using these expandable particles as a starting material, the foamed cellular particles were produced in a fluid bed dryer with a glass body (Lab-Line Hi-Speed Bed Dryer Model #23850 (1985)). The resulting material had a pentane content of 3.4%.

For comparison purposes, a conventional expandable polystyrene (EPS) homopolymer sample, (i.e. not containing butyl acrylate) containing 4.33% total pentane was used.

Both materials were then expanded in a non-agitated, 2-gallon batch expander with a perforated screen bottom. Atmospheric steam was introduced through the screen into the bottom of the expander and the particles were expanded for varying times in minutes. Fifty-gram feed charges were used for each experiment. The results appear in Table 2.

TABLE 2

| | | BULK DENSITY |
|---|---|---|
| | EXPANSION | (pounds per |
| SAMPLE | TIME | cubic foot) |
| Conventional EPS with 4.33% | 2 minutes | 1.80 |
| Pentane | | |
| Conventional EPS with 4.33% | 3 minutes | 1.67 |
| Pentane | | |
| Conventional EPS with 4.33% | 4 minutes | 1.49 |
| Pentane | | |
| Foamed Cellular Particles | 2 minutes | 1.57 |
| with 3.46% Pentane | | |
| Foamed Cellular Particles | 3 minutes | 1.34 |
| with 3.46% Pentane | | |
| Foamed Cellular Particles | 4 minutes | 1.19 |
| with 3.46% Pentane | | |

The results in Table 2 indicate that the foamed cellular particles (containing butyl acrylate) expand to a lower bulk density even though they contain 20% less pentane than the conventional expandable polystyrene (EPS) sample (not containing butyl acrylate).

### Example 9

This Example 9 demonstrates the superior expandability of the foamed cellular particles versus conventional expandable polystyrene (EPS) particle when evaluated at equivalent pentane blowing agent contents.

The control sample was conventional expandable polystyrene with a bulk density of 39 pounds per cubic foot, an average bead size of 0.95 mm., and a total pentane content of 3.0%. The experimental sample was foamed cellular particles formed in accordance with the teachings of the present invention. This example sample had a bulk density of 25 pounds per cubic foot, an average bead size of 1.11 mm., and a total pentane content of 2.98%.

Both samples were surface-coated with the same type of composition in similar amounts. The composition was a mix of glycerol mono-stearate, glycerol tri-stearate, calcium stearate, and silicone fluid. Both samples were expanded in a Hirsch® Vacutrans 3000-H batch pre-expander to a final “prepuff” bulk density of 1.8 pounds per cubic foot. The expansion conditions and results are shown in the Table 3.

TABLE 3

| | | FOAMED CELLULAR |
|---|---|---|
| EXPANSION | CONVENTIONAL | PARTICLES OF |
| CONDITIONS | EPS | PRESENT INVENTION |
| Steam pressure, (psig) | 0.32 | 0.32 |
| Expander fill time | 10 | 10 |
| (seconds) | | |
| Transfer time | 10 | 10 |
| (seconds) | | |
| Vacuum time | 10 | 10 |
| (seconds) | | |
| Expansion rate | 144.4 | 351.5 |
| (pounds per hour) | | |

As can be seen in Table 3, at equivalent starting total pentane levels, identical lube coating amounts and compositions, and under identical expansion conditions, the foamed cellular particles of the invention displayed 143% higher expansion rates than the conventional expandable polystyrene (EPS).

While the present invention has been particularly set forth in terms of specific embodiments thereof, it will be understood in view of the instant disclosure that numerous variations upon the invention are now enabled yet reside within the scope of the invention. Accordingly, the invention is to be broadly construed and limited only by the scope and spirit of the claims now appended hereto.

What is claimed is:

1. Foamed cellular particles for use in forming foam articles and said foamed cellular particles formed from expandable polymer particles, said foamed cellular particles having a bulk density ranging between about 34.3 pounds per cubic foot (550 kilograms per cubic meter) and 12.5 pounds per cubic foot (200 kilograms per cubic meter) and a blowing agent in an amount less than 6.0 wt % based on the polymer, and for a predetermined time at room temperature having a blowing agent weight loss at least 15% to 50% lower compared to said expandable particles in the same predetermined time at room temperature.

2. Foamed cellular particles of claim 1 wherein said blowing agent is selected from the group consisting of acetone, methyl acetate, butane, hexane, n-pentane, cyclopentane, cyclohexane, isopentane, isobutane, neopentane, HFC's, CFC's, HCFC's, water, and mixtures thereof in combination with carbon dioxide, nitrogen, and air in an amount ranging between 2.0 wt % and 5.0 wt %.

3. Foamed cellular particles of claim 2 wherein said blowing agent is selected from the group consisting of acetone, methyl acetate, butane, hexane, n-pentane, cyclopentane, cyclohexane, isopentane, isobutane, neopentane, and mixtures thereof in an amount ranging between 2.5 wt % and 3.5 wt %.

4. Foamed cellular particles of claim 3 wherein said blowing agent is n-pentane and mixtures thereof in an amount ranging between 2.5 wt % and 3.5 wt %.

5. Foamed cellular particles of claim 1 wherein said particles contain an established cell structure comprising an average cell size ranging between 5 and 100 microns and a fixed number of cells.

6. Foamed cellular particles of claim 1 wherein said foamed cellular particles are comprised of a polymer composition comprised of: i) at least one C₈-C₁₂ vinyl aromatic monomer which is unsubstituted or substituted by one or more substituents selected from the group consisting of C₁₋₆ alkyl radicals and halogen atoms in an amount ranging from about 70 to about 100 weight %, ii) at least one monomer selected from the group consisting of C₃₋₆ ethylenically unsaturated carboxylic acids, anhydrides, imides and C₁₋₁₂ alkyl and alkoxyalkyl esters thereof, and C₃₋₆ ethylenically unsaturated nitrites in an amount ranging from about 30 to 0 weight % based on the weight of the polymer composition, and iii) a blowing agent.

7. Foamed cellular particles of claim 6 wherein i) is selected from the group consisting of styrene, alpha methyl styrene, para methyl styrene, chlorostyrene and bromo-styrene, ii) is selected from the group consisting of methyl acrylate, ethyl acrylate, butyl acrylate, methyl methacrylate, ethyl methacrylate, acrylonitrile, methacrylonitrile, maleic anhydrided, acrylic acid, methacrylic acid, itaconic acid, and maimide, and iii) is selected from the group consisting of acetone, methyl acetate, butane, hexane, n-pentane, cylcopentane, isopentane, isobutane, neopentane, HFC's, CFC's, HCFC's, water and mixtures thereof.

8. Foamed cellular particles of claim 7 wherein i) is styrene, ii) is butyl acrylate, and iii) is n-pentane and mixtures thereof.

9. Foamed cellular particles of claim 1 wherein said foamed cellular particles are comprised of a polymer composition comprised of: i) at least one C₈-C₁₂ vinyl aromatic monomer which is unsubstituted or substituted by one or more substituents selected from the group consisting of C₁₋₆ alkyl radicals and halogen atoms in an amount ranging from about 70 to about 100 weight %, ii) at least one polymer selected from the group consisting of polyphenylene oxide, butadiene rubber, and high impact polystyrene in an amount ranging between about 30 and 0 weight and iii) a blowing agent.

10. Foamed cellular particles of claim 9 wherein i) is selected from the group consisting of styrene, alpha methyl styrene, para methyl styrene, chlorostyrene and bromo-styrene and iii) is selected from the group consisting of acetone, methyl acetate, butane, hexane, n-pentane, cyclopentane, isopentane, isobutane, neopentane, HFC's, CFC's, HCFC's, water, and mixtures thereof.

11. Foamed cellular particles of claim 1 wherein said expandable polymer particles are formed in a polymerization process selected from the group consisting of suspension, bulk, and solution.

12. Foamed cellular particles of claim 11 wherein said polymerization process is a suspension process.

13. Foamed cellular particles of claim 12 wherein said suspension process is selected from the group consisting of one-step and two-step processes.

14. Foamed cellular particles of claim 1 wherein said expandable polymer particles are formed in an extrusion process.

15. Foamed cellular particles of claim 1 wherein said foamed cellular particles are formed in a heating process selected from the group consisting of contact heating, non-contact heating, infrared heating, microwave heating, dielectric heating, and radio frequency heating.

16. Foamed cellular particles of claim 1 wherein said foamed cellular particles are formed in a heating process including a fluid bed dryer.

17. Foamed cellular particles of claim 1 wherein said foamed cellular particles are formed in a heating process including a pre-expander.

18. Foamed cellular particles of claim 1 wherein said expandable particles are produced from a polymer composition in a suspension polymerization process, the steps comprising:
admixing at least one styrenic monomer in an amount ranging from about 70 to about 100 weight % based on the amount of polymer composition with at least one vinyl group monomer in an amount ranging from about 30 to 0 weight % based on the polymer composition to form expandable particles, and
prior to, during, or after said suspension polymerization process mixing in said blowing agent selected fromthe group consisting of acetone, methyl acetate, butane, n-pentane, cyclopentane, cyclohexane, isopentane, neopentane, isobutane, hexane, HFC's, CFC's, HCFC's, water, and mixtures thereof with said styrenic monomer and vinyl group monomer.

19. Foamed cellular particles of claim 1 wherein said expandable particles are produced from a polymer composition in a suspension polymerization process, the steps comprising:
admixing at least one styrenic monomer in an amount ranging from about 70 to about 100 weight % based on the amount of polymer composition with at least one polymer selected from the group consisting of polyphenylene oxide, butadiene rubber, and high impact polystyrene in an amount ranging between about 30 and 0 weight % based on the polymer composition to form expandable particles, and
prior to, during, or after said suspension polymerization process, mixing in said blowing agent selected from the group consisting of acetone, methyl acetate, butane, n-pentane, cyclopentane, cyclohexane, isopentane, neopentane, isobutane, hexane, HFC's, CFC's, HCFC's, water, and mixtures thereof with said styrenic monomer and said polymer.

20. Foamed cellular particles of claim 1 wherein said expandable particles are produced from a polymer composition in an extrusion process, the steps comprising:
admixing a styrenic polymer in an amount ranging between about 70 and about 100 weight % based on the amount of polymer composition with at least one vinyl group polymer in an amount ranging between about 30 and 0 weight % based on the polymer composition,
heating and admixing said polymer composition to obtain a polymer melt and injecting said blowing agent selected from the group consisting of acetone, methyl acetate, butane, n-pentane, isobutane, cyclopentane, cyclohexane, isopentane, neopentane, hexane, HFC's, CFC's, HCFC's, water, and mixtures thereof,
extruding the polymer melt as a strand and chopping it into pellets, and
heating the pellets to a temperature range of about 70 and 110° C. at a pressure range of about 10.1 psi absolute (70 kPa) to about 24.7 psi absolute (170 kPa) thereby forming said foamed cellular particles.

21. Foamed cellular particles of claim 1 wherein said expandable particles are produced from a polymer composition in an extrusion process, the steps comprising:
admixing a styrenic polymer in an amount ranging between about 70 and about 100 weight % based on the amount of polymer composition with at least one polymer selected from the group consisting of polyphenylene oxide, butadiene rubber, and high impact polystyrene in an amount ranging between about 30 and 0 weight % based on the polymer composition,
heating and admixing said polymer composition to obtain a polymer melt,
extruding the polymer melt as a strand and chopping said strand into pellets,
impregnating the pellets with said blowing agent selected from the group consisting of acetone, methyl acetate, butane, n-pentane, isobutane, cyclopentane, cyclohexane, isopentane, neopentane, hexane, HFC's, CFC's, HCFC's, water, and mixtures thereof, and
heating the pellets to a temperature range of about 70 and 110° C. at a pressure range of about 10.1 psi absolute (70 kPa) to about 24.7 psi absolute (170 kPa) thereby forming said foamed cellular particles.

22. Foamed cellular particles of claim 1 wherein at least said foamed particles contain a coating composition.

23. Foam particles of claim 22 wherein said coating composition is selected from the group consisting of silicones, metals, and glycerol carboxylates, and mixtures thereof.

24. Foam particles of claim 23 wherein said glycerol carboxylates are selected from the group consisting of glycerol mono-stearate, glycerol di-stearate, glycerol tri-stearate, zinc stearate, calcium stearate, and magnesium stearate, and mixtures thereof.

25. A system for extending the shelf life of expandable polymer particles by making said foamed cellular particles of claim 1.

26. A foam article formed from the foamed cellular particles of claim 1 and having a bulk density ranging between about 0.50 pounds per cubic foot (8.0 kilograms per cubic meter) and 6.0 pounds per cubic foot (96.1 kilograms per cubic meter).

27. A process for preparing foamed cellular particles comprised of a polymer composition for use in making foam articles, the steps comprising:
a) heating expandable polymer particles with a bulk density ranging between about 40 pounds per cubic foot (641 kilograms per cubic meter) and about 32.0 pounds per cubic foot (513 kilograms per cubic meter) and a blowing agent in an amount less than about 10.0 weight % based on the weight of the polymer composition at a temperature ranging between about 70 and 110° C. and at a pressure ranging between about 10.1 psi absolute (70 kPa) and about 24.7 psi absolute (170 kPa) to form said foamed cellular particles with a bulk density ranging from between 34.3 pounds per cubic foot (550 kilograms per cubic meter) and about 12.5 pounds per cubic foot (200 kilograms per cubic meter) and a blowing agent in an amount less than about 6.0 weight % based on the weight of the polymer composition.

28. A process of claim 27 wherein step a) is performed at a polymer producer's plant, and the steps further comprising:
b) at a foam molder's plant, subjecting said foamed cellular particles to conventional equipment to form foam articles with a bulk density ranging between about 0.80 pounds per cubic foot (12.8)kilograms per cubic meter) and 6.0 pounds per cubic foot (96.1 kilograms per cubic meter) without the need to impregnate said foamed cellular particles with an additional amount of blowing agent prior to expanding and molding.

29. A system for optimizing the shipping and packaging of polymer particles for use in making foam articles, the steps comprising:
at the polymer producer's plant,
a) using expandable polymer particles with a bulk density ranging between about 40 pounds per cubic foot (641 kilograms per cubic meter) and about 32.0 pounds per cubic foot (513 kilograms per cubic meter) and a blowing agent in an amount less than about 10.0 weight % based on the weight of the polymer composition and heating said expandable particles at a temperature ranging between about 70° C. and about 110° C. and at a pressure ranging between about 10.1 psi absolute (70 kPa absolute)and about 24.7 psi absolute (170 kPa absolute) to form foamed cellular particles with a bulk density ranging from between about 34.3 pounds per cubic foot (550 kilograms per cubic meter) and about 12.5 pounds per cubic foot (200 kilograms per cubic meter) and with a blowing agent in an amount less than 6.0 weight % based on the weight of the polymer composition;
b) packaging said foamed cellular particles of step a) whereby the required strength of the packages used in transporting the foamed cellular particles of step a) is lower than the required strength of packages used when transporting the expandable particles with a higher bulk density and higher blowing agent level of step a); and
c) transporting said foamed cellular particles at a total shipment weight substantially equal to the total shipment weight of the expandable particles of step a) when transporting said expandable particles.

30. A system of claim 29 wherein in step a) said expandable particles are heated at a temperature ranging between 80° C. and 110° C. and at a pressure of about 13.8 psi absolute (95 kPa absolute) and about 16 psi absolute (110 kPa absolute) for about 0.05 to 60 minutes; wherein the bulk density of said foamed cellular particles ranges between about 28.1 pounds per cubic foot (450 kilograms per cubic meter) and about 21.9 pounds per cubic foot (350 kilograms per cubic meter); and wherein said blowing agent in the foamed cellular particles is in an amount ranging between about 2.0 wt % and 5.0 wt %.

31. A system of claim 29 wherein said blowing agent is selected from the group consisting of acetone, methyl acetate, butane, hexane, n-pentane, cyclopentane, cyclohexane, isobutane, isopentane, neopentane, HFC's, CFC's, HCFC's, water, and mixtures thereof in combination with carbon dioxide, nitrogen, and air.

32. A system of claim 31 wherein said blowing agent is selected from the group consisting of acetone, methyl acetate, butane, hexane, n-pentane, cyclopentane, cyclohexane, isopentane, isobutane, neopentane, and mixtures thereof in an amount ranging between 2.5 and 3.5 weight % based on the weight of the polymer composition.

33. A system of claim 32 wherein said blowing agent is selected from the group consisting of pentane and mixtures thereof in an amount ranging between 2.5 and 3.5 weight % based on the weight of the polymer composition.

34. A system of claim 29 wherein the packages used in transporting the cellular particles are selected from the group consisting of paper bags, plastic film bags, fiber cartons, metal drums, fiber drums, bulk bags, and returnable packaging.

35. A system of claim 29 wherein the total weight of the foamed cellular particles of step c) transported by said transportation means is about 30,000 to about 50,000 pounds.

36. A system of claim 29 wherein said expandable polymer particles are formed in a polymerization process selected from the group consisting of suspension, bulk, and solution.

37. A system of claim 36 wherein said polymerization process is a suspension process.

38. A system of claim 37 wherein said suspension polymerization process is selected from the group consisting of one-step and two-step processes.

39. A system of claim 29 wherein said expandable polymer particles are formed in an extrusion process.

40. A system of claim 29 wherein said foamed cellular particles are transported to a foam molder's plant and the steps further comprising:
d) in said foam molder's plant, subjecting said foamed cellular particles to conventional equipment to form a foam article with a bulk density ranging between about 0.80 pounds per cubic foot(12.8 kilograms per cubic meter) and 6.0 pounds per cubic foot (96.1 kilograms per cubic meter) without the need to impregnate said foamed cellular particles with an additional amount of blowing agent prior to expanding and molding.

41. A system of claim 29 wherein said foamed cellular particles are formed in a heating process selected from the group consisting of contact heating, non-contact heating, infrared heating, microwave heating, dielectric heating, and radio frequency heating in said plant of said polymer producer.

42. A system of claim 31 wherein said foamed cellular particles are formed in a heating process including a fluid bed dryer.

43. A system of claim 29 wherein each said foamed cellular particle has an established cell structure comprising an average cell size ranging between 5 and 100 microns and a fixed number of cells.

44. A system of claim 29 wherein said expandable particles are produced from a polymer composition in a suspension polymerization process, the steps comprising:
admixing at least one styrenic monomer in an amount ranging from about 70 to about 100 weight % based on the amount of polymer composition with at least one vinyl group monomer in an amount ranging from about 30 to 0 weight % based on the polymer composition to form expandable particles, and
prior to, during, or after said suspension polymerization process mixing in said blowing agent selected from the group consisting of acetone, methyl acetate, butane, n-pentane, cyclopentane, cyclohexane, isopentane, neopentane, isobutane, hexane, HFC's, CFC's, HCFC's, water, and mixtures thereof with said styrenic monomer and vinyl group monomer.

45. A system of claim 29 wherein said expandable particles are produced from a polymer composition in a suspension polymerization process, the steps comprising:
admixing at least one styrenic monomer in an amount ranging from about 70 to about 100 weight % based on the amount of polymer composition with at least one polymer selected from the group consisting of polyphenylene oxide, butadiene rubber, and high polystyrene in an amount ranging between about 30 and 0 weight % based on the polymer composition to form expandable particles, and
prior to, during, or after said suspension polymerization process, mixing in said blowing agent selected from the group consisting of acetone, methyl acetate, butane, n-pentane, cyclopentane, cyclohexane, isopentane, neopentane, isobutane, hexane, HFC's, CFC's, HCFC's, water, and mixtures thereof with said styrenic monomer and said polymer.

46. A system of claim 29 wherein said expandable particles are produced from a polymer composition in an extrusion process, the steps comprising:
admixing a styrenic polymer in an amount ranging between about 70 and about 100 weight % based on the amount of polymer composition with at least one vinyl group polymer in an amount ranging between about 30 and 0 weight % based on the polymer composition,
heating and admixing said polymer composition to obtain a polymer melt and injecting said blowing agent selected from the group consisting of acetone, methyl acetate, butane, n-pentane, isobutane, cyclopentane, cyclohexane, isopentane, neopentane, hexane, HFC's, CFC's, HCFC's, water, and mixtures thereof,
extruding the polymer melt as a strand and chopping it into pellets, and
heating the pellets to said temperature range of about 70 and 110° C. at said pressure range of about 10.1 psi absolute to about 24.7 psi absolute thereby forming said foamed cellular particles.

47. A system of claim 29 wherein said expandable particles are produced from a polymer composition in an extrusion process, the steps comprising:
admixing a styrenic polymer in an amount ranging between about 70 and about 100 weight % based on the amount of polymer composition with at least one polymer selected from the group consisting of polyphenylene oxide, butadiene rubber, and high impact polystyrene in an amount ranging between about 30 and 0 weight % based on the polymer composition,
heating and admixing said polymer composition to obtain a polymer melt,
extruding the polymer melt as a strand and chopping said strand into pellets,
impregnating the pellets with said blowing agent selected from the group consisting of acetone, methyl acetate, butane, n-pentane, isobutane, cyclopentane, cyclohexane, isopentane, neopentane, hexane, HFC's, CFC's, HCFC's, water, and mixtures thereof, and
heating the pellets to said temperature range of about 70 and 110° C. at said pressure range of about 10.1 psi absolute to about 24.7 psi absolute thereby forming said foamed cellular particles.

48. A system of claim 29 the steps further comprising:
prior to, during, or after step a) applying a coating composition to said expandable polymer particles or to said foamed cellular particles.

49. Foamed cellular particles of claim 1 wherein said expandable particles are produced from a polymer composition formed in a polymerization process in an extruder, the steps comprising:
admixing a styrenic monomer in an amount ranging between about 70 and 100 weight % based on the amount of monomer composition with at least one vinyl group monomer in an amount ranging between about 30 and 0 weight % based on the monomer composition to form said polymer composition,
heating said polymer composition to obtain a polymer melt and injecting said blowing agent selected from the group consisting of acetone, methyl acetate, butane, n-pentane, isobutane, cyclopentane, cyclohexane, isopentane, neopentane, hexane, HFC's, CFC's, HCFC's, water, and mixtures thereof,
extruding the polymer melt as a strand and chopping it into pellets, and
heating the pellets to a temperature range of about 70 and 110° C. at a pressure range of about 10.1 psi absolute (70 kPA) to about 24.7 psi absolute (170 kPA) thereby forming said foamed cellular particles.

50. A system of claim 29 wherein said expandable particles are produced from a polymer composition formed in a polymerization process in an extruder, the steps comprising:
admixing a styrenic monomer in an amount ranging between about 70 and 100 weight % based on the amount of monomer composition with at least one vinyl group monomer in an amount ranging between about 30 and 0 weight % based on the monomer composition to form said polymer composition,
heating said polymer composition to obtain a polymer melt and injecting said blowing agent selected from the group consisting of acetone, methyl acetate, butane, n-pentane, isobutane, cyclopentane, cyclohexane, isopentane, neopentane, hexane, HFC's, CFC's, HCFC's, water, and mixtures thereof,
extruding the polymer melt as a strand and chopping it into pellets, and
heating the pellets to a temperature range of about 70 and 110° C. at a pressure range of about 10.1 psi absolute (70 kPA) to about 24.7 psi absolute (170 kPA) thereby forming said foamed cellular particles.
